(19) United States
(12) Patent Application Publication
(10) Pub. No.: US 2026/0284837 A1
(43) Pub. Date: Sep. 24, 2026

(54) IMPROVED TORQUE LIMITING MECHANISM

(71) Applicant: Bartosz Markiewicz, Milton (CA)

(72) Inventor: Bartosz Markiewicz, Milton (CA)

(21) Appl. No.: 19/472,143

(22) PCT Filed: Apr. 3, 2024
(86) PCT No.: PCT/CA2024/050423

§ 371 Date: Oct. 3, 2025

Related U.S. Application Data
(60) Provisional application No. 63/456,541, filed on Apr. 3, 2023.

(51) Int. Cl. B25B 13/50; B25B 23/14; B25B 23/142; B25B 27/00

(52) U.S. Cl. CPC B25B 13/5008; B25B 23/141; B25B 23/1427; B25B 27/0042

(57) ABSTRACT

A torque limiting mechanism can include a housing having a bore. A cam is positioned within the bore and includes a plurality of circumferentially extending notches, each of the notches having a first pocket and a radially spaced apart second pocket. Detent elements are receivable by the notches. The cam is rotatable within the bore between a torque application position and a signaling position. In the torque application position, the detent elements engage the first pockets of the notches. In the signaling position, the detent elements engage the second pockets of the notches. The torque limiting mechanism can be implemented with an oil filter socket or wrench.

### CROSS REFERENCE TO RELATED APPLICATION

This application claims priority to U.S. Patent Application No. 63/456,541 filed on Apr. 3, 2023, the entire contents of which are hereby incorporated herein by reference.

### TECHNICAL FIELD

The present disclosure relates generally to the field of torque limiting mechanisms. More particularly, the present disclosure relates to oil filter sockets having a torque limiting mechanism for removing an oil filter from an engine.

### BACKGROUND

The following paragraphs are not an admission that anything discussed in them is prior art or part of the knowledge of persons skilled in the art.

U.S. Pat. No. 2,948,173 (Herrmann) discloses a hand tool holder for a rotary tool, which is adapted to impart to the tool only a limited, predetermined amount of driving torque.

U.S. Pat. No. 8,161,849 (Stark) discloses an adjustable torque limiter that can be coupled between a high speed driver and the socket that rotates a mechanical fastener. When a preset torque level is reached, the torque limiter disengages the rotational drive force from the bit. The adjustability of the torque limitation is accomplished by varying the amount of spring force by which a thrust plate (coupled to the high speed driver) is forced against a set of steel balls residing in slots of a radial torque plate and in a set of paths formed in a concavity of an upper torque body (coupled to the driven socket engaging stud). When a certain preset torque is transmitted from the driver to the socket, the steel balls traverse outward along the separate arced ramp radial paths therein the upper torque body until the balls enter an annular race that allows the thrust plate to go into a disengaged or free wheel mode from the upper torque body.

U.S. Pat. No. 9,925,650 (Markiewicz) discloses an oil filter socket having a torque limited maximum. Namely, a torque limiting mechanism is provided interior a bore defined by a nut adapted to receive a conventional ratchet. The torque limiting mechanism includes a cam having bearing race notches formed circumferentially there-around. A plurality of ball bearings rest inside the notches until the rotational torque force applied to the socket from the ratchet overcomes the spring force acting opposite the cam.

### INTRODUCTION

The following is intended to introduce the reader to the detailed description that follows and not to define or limit the claimed subject matter.

In an aspect of the present disclosure, a torque limiting mechanism can include: a housing extending between a first housing end and a second housing end, the housing including a bore extending along a central axis within the housing and terminating at a bore base end; a cam positioned within the bore and extending axially between a cam first end and a cam second end, the cam biased toward the bore base end, and the cam second end including a plurality of circumferentially extending notches, each of the notches having a first pocket and a radially spaced apart second pocket, the first pocket has a first tangential angle, the second pocket has a second tangential angle that is not equal to the first tangential angle; and a plurality of detent elements extending into the bore from the bore base end, each detent element receivable by a respective notch. The cam can be rotatable within the bore about the central axis between a torque application position and a signaling position. In the torque application position, the detent elements can engage respective first pockets of the plurality of notches. In the signaling position, the detent elements can engage respective second pockets of the plurality of notches.

In some examples, each notch has a first sidewall extending from a deepest point of the notch to the cam second end, and a second sidewall extending away from the first sidewall from the deepest point of the notch to the cam second end, the second sidewall defines the first pocket and the second pocket. In some examples, the first sidewall defines a third pocket, the third pocket has a third tangential angle, and the third tangential angle is less than the first tangential angle and the second tangential angle. In some examples, the third tangential angle is less than 5 degrees.

In some examples, the cam second end has a cam second end surface, and a portion of the cam second end surface extends between adjacent notches. In some examples, the cam is rotatable from the signaling position, away from the torque application position, to a slip position, and in the slip position, the detent elements engage respective portions of the second end surface extending between adjacent notches. In some examples, the portion of the second end surface that extends between adjacent notches is recessed toward the deepest point of the notch.

In some examples, the second tangential angle is greater than the first tangential angle. In some examples, a distance that each detent element extends into the bore from the bore base end is adjustable. In some examples, each detent element includes a ball bearing that engages the notches.

In some examples, the torque limiting mechanism further includes a spring interior the bore for biasing the cam toward the plurality of detent elements. In some examples, the spring is a variable-rate spring. In some examples, a portion of an inner surface of the bore is threaded and a threaded disc is received by the bore to secure the spring within the bore. In some examples, the threaded disc is moveable between a first securing position and a second securing position, and a torque limit when the threaded disc is in the first securing position is less than a torque limit when the threaded disc is in the second securing position.

In some examples, the bore extends into the housing from the first housing end, and the bore base end is axially spaced from the housing second end. In some examples, the housing includes an opening that extends from the second housing end to the bore. In some examples, the cam includes a receiving hole and, in use, a drive extension extends through the opening and engages the receiving hole. In some examples, the cam includes six notches, and the plurality of detent elements consists of three detent elements.

In an aspect of the present disclosure, an oil filter socket can include: the torque limiting mechanism disclosed herein; and a cup including a first end and a second end. The first end of the cup can define a cavity that is sized and shaped to grip one of an oil filter canister and an oil filter bolt head, and the torque limiting mechanism is coupled to the second end of the cup.

In an aspect of the present disclosure, a method can include: providing the oil filter socket disclosed herein; setting a torque limit with the torque limiting mechanism; connecting the oil filter socket to one of an oil filter canister and an oil filter bolt head; and rotating the oil filter socket until the detent elements shift from engaging the first pockets to engaging the second pockets signaling that the torque limit has been reached.

In an aspect of the present disclosure, a mechanism can include: a housing; a cam; and at least one detent element. The cam can include at least one notch, the notch including a first pocket and a second pocket. The at least one detent element can engage the first pocket of the at least one notch when a first torque is applied to the cam. The at least one detent element can engage the second pocket of the at least one notch when a second torque is applied to the cam.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a perspective view of an example of a torque limiting wrench system coupled to an oil filter.

FIG. 2 is a top view of the torque limiting wrench system of FIG. 1.

FIG. 3 is a bottom view of the torque limiting wrench system of FIG. 1.

FIG. 4 is a cross-sectional view taken along line IV-IV in FIG. 2.

FIG. 5 is an enlarged view of a portion of FIG. 4.

FIG. 6 is an upper perspective view of an oil filter socket of the torque limiting wrench system of FIG. 1.

FIG. 7 is an upper perspective view of a torque limiting mechanism of the oil filter socket of FIG. 6.

FIG. 8 is a lower perspective view of the torque limiting mechanism of FIG. 7.

FIG. 9 is an exploded view of the torque limiting mechanism of FIG. 7.

FIG. 10 is an upper perspective view of a cam of the torque limiting mechanism of FIG. 7.

FIG. 11 is a lower perspective of the cam of FIG. 10.

FIG. 12 is a side view of the cam of FIG. 10.

FIG. 13 is a cross-sectional view taken along line XIII-XIII in FIG. 7, with the torque limiting mechanism in a torque application position.

FIG. 14 is a cross-sectional view taken along line XIII-XIII in FIG. 7, with the torque limiting mechanism in a torque signaling position.

FIG. 15 is a cross-sectional view taken along line XIII-XIII in FIG. 7, with the torque limiting mechanism in an over torque position.

FIG. 16 is an upper perspective view of another example of an oil filter socket.

FIG. 17 is an upper perspective view of another example of an oil filter socket.

FIG. 18A is an upper perspective view of another example of a torque limiting mechanism.

FIG. 18B is a lower perspective view of the torque limiting mechanism of FIG. 18A.

FIG. 18C is an exploded view of the torque limiting mechanism of FIG. 18A.

### DETAILED DESCRIPTION

Various apparatuses and methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

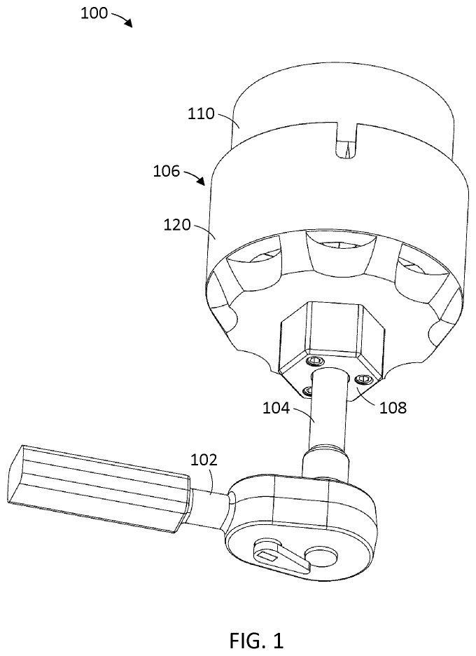

Referring to FIG. 1, shown therein is an example of a filter wrench system 100. In the example illustrated, the filter wrench system 100 includes a socket wrench or ratchet 102, a drive extension 104, and an oil filter socket 106 having a torque limiting mechanism 108 therein. In FIG. 1, the oil filter socket 106 is shown engaging an oil filter 110.

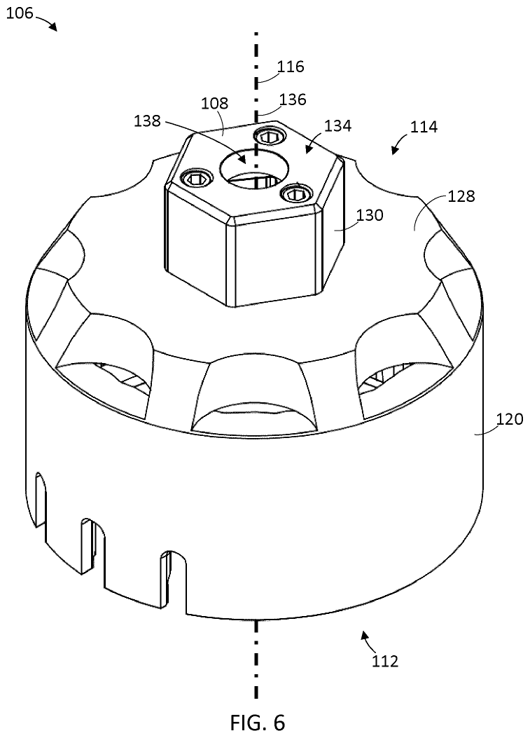

Referring to FIG. 6, the oil filter socket 106 includes a first socket end 112 opposite a second socket end 114. A central axis 116 of the oil filter socket 106 extends between the first socket end 112 and the second socket end 114. As shown in FIG. 6, the oil filter socket 106 includes a cup 120 and a torque limiting mechanism 108. The cup 120 is sized and shaped to receive an oil filter 110 (see FIG. 1). The torque limiting mechanism 108 is for transferring rotational force applied by an operator to the ratchet 102 (and the drive extension 104) to the cup 120.

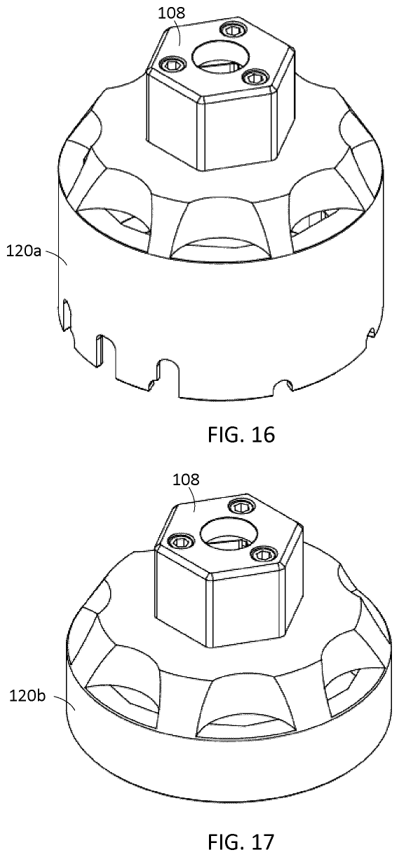

In some examples, as shown in FIG. 6, the torque limiting mechanism 108 may be integrally formed with the cup 120. In other examples, the torque limiting mechanism 108 is releasably securable to the cup 120. It may be desirable for the torque limiting mechanism 108 to be releasably securable to the cup 120 so a single torque limiting mechanism 108 may be used with multiple cups 120, each shaped and sized for a specific oil filter 110. Non-limiting examples of differently shaped and sized cups, cup 120a and cup 120b, are shown in FIGS. 16 and 17. In addition, the torque limiting mechanism 108 may be used with additional socket type attachments (e.g. a wheel nut socket, engine drain plug socket, etc.). That is, while the description that follows and the drawings show a torque limiting mechanism 108 paired with a cup 120 for removing/securing an oil filter 110, in other examples, the torque limiting mechanism 108 described herein may be integrated into and/or securable to other ratchet attachments for other purposes.

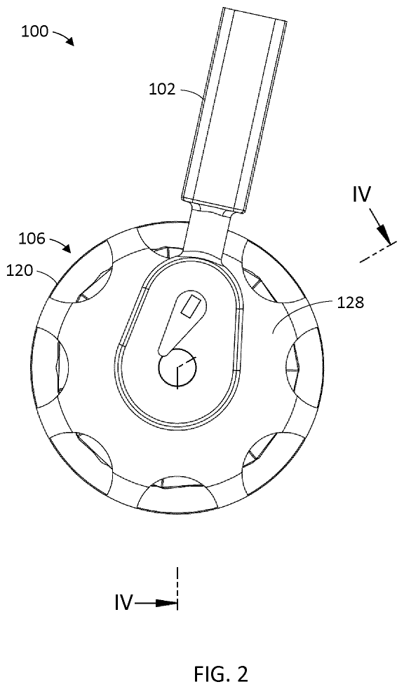

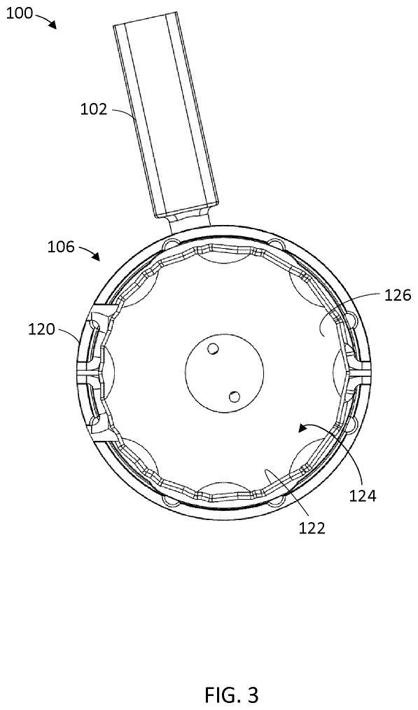

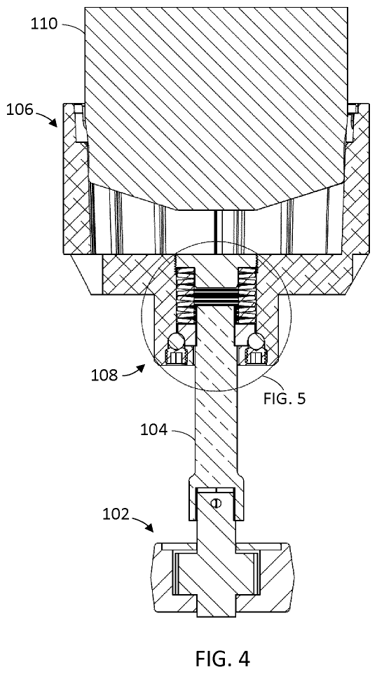

As shown in FIGS. 2 and 3, the cup 120 has an annular edge 122 at the first socket end 112 which defines an opening to an oil filter cavity 124. The oil filter cavity 124 may be defined by an inner surface 126 of the cup 120 and is shaped and sized to grip the oil filter 110. In the example shown (see FIG. 2), the cup 120 further includes a closed end 128 offset from the first socket end 112. The cup 120 may be of any shape and size configured for receiving and gripping an oil filter 110.

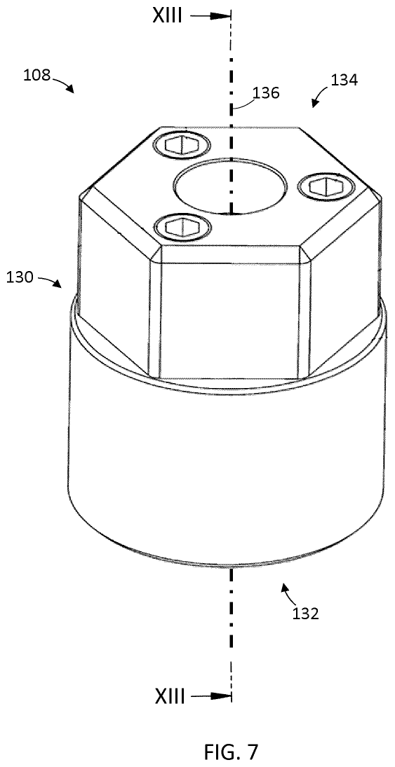

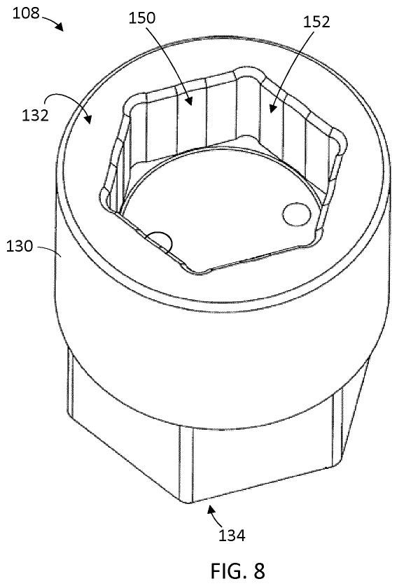

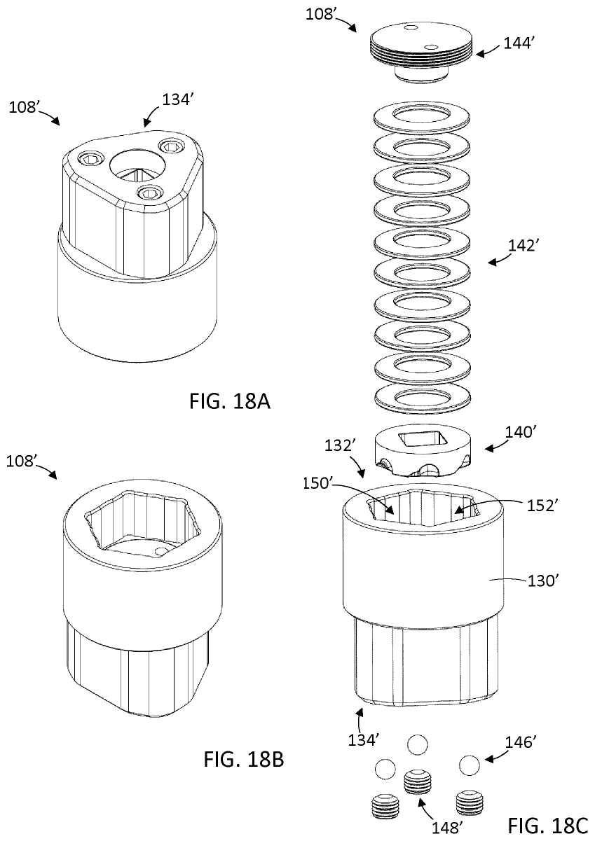

Referring to FIGS. 7 and 8, the torque limiting mechanism 108 includes a housing 130 extending between a first housing end 132 and a second housing end 134. A central axis 136 of the torque limiting mechanism 108 extends between the first housing end 132 and the second housing end 134. In the example shown in FIG. 6, the central axis 136 of the torque limiting mechanism 108 is aligned with the central axis 116 of the oil filter socket 106. The torque limiting mechanism 108 may be arranged at the closed end 128 of the cup 120, with the housing 130 centered about the central axis 116 of the oil filter socket 106. The second housing end 134 may extend outwardly from the cup 120. Optionally, as shown in FIG. 6, the second housing end 134 may be shaped to resemble a nut so that the second housing end 134 may be readily gripped by a wrench. In other examples (see FIGS. 18A to 18C), the second housing end 134′ may not be shaped to resemble a nut, and may, for example, have a triangular cross-sectional shape. It may be desirable to provide a second housing end 134′ that is not shaped to resemble a nut to reduce the likeliness of an operator gripping the second housing end 134′ with, for example, a wrench and applying additional torque (i.e. over torquing). With the exception of the shape of the second housing end 134′, the torque limiting mechanism 108′ shown in FIGS. 18A to 18C can be identical to what is shown in FIGS. 7 to 9, with like parts marked alike.

In the example shown in FIG. 6, the housing 130 includes an opening 138 at the second housing end 134. The opening 138 is sized and shaped to receive the drive extension 104 (see FIG. 1).

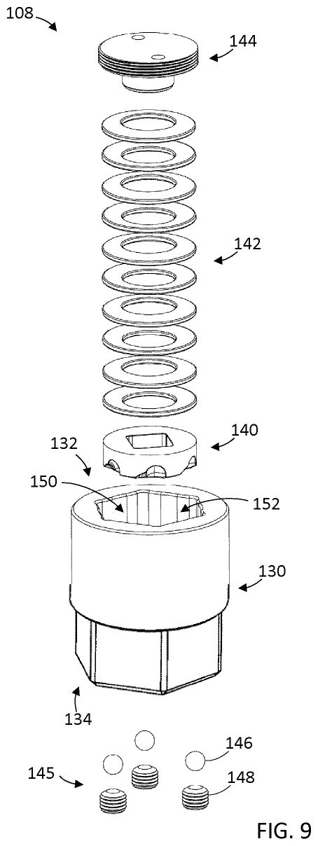

Referring to FIG. 9, within the housing 130, the torque limiting mechanism 108 includes a cam 140, a spring 142, a threaded disc 144, and a plurality of detent elements 145. In the example shown, each detent element 145 includes a ball bearing 146 and a set screw 148. In other example, detent elements may not be configured as separate ball bearings and set screws. For example, a detent element may be configured as a ball bearing that is integrally formed with a set screw, or a detent element may be configured as a dome shaped protuberance.

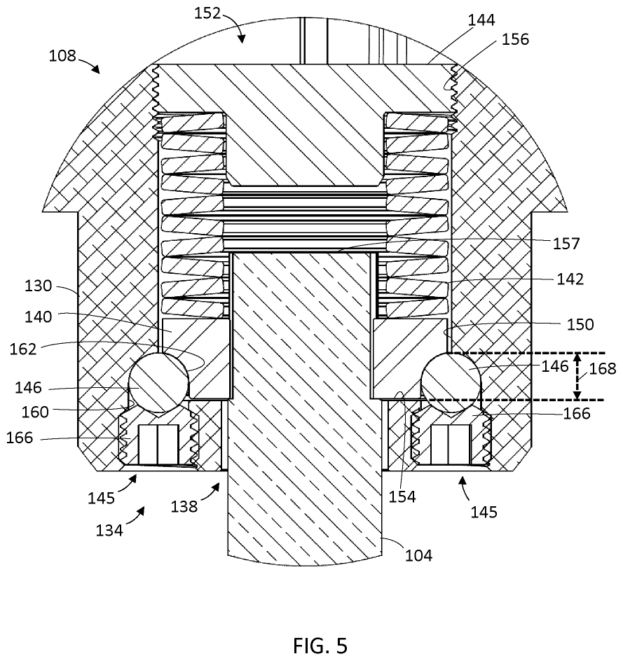

With reference to FIGS. 5, 8, 9 and 13, in the example shown, the housing 130 of the torque limiting mechanism 108 may include a bore 150 extending longitudinally from a bore opening 152 at the first housing end 132 to a base end 154 positioned toward the second housing end 134.

As shown in FIG. 9, the bore 150 may receive the cam 140, the spring 142, and the threaded disc 144 through the bore opening 152 and may house the cam 140, the spring 142, and the threaded disc 144 within the bore 150. As shown in FIG. 5, at least a portion of the bore 150 at the bore opening 152 may be internally threaded. The internal threads 156 of the bore 150 may engage the threaded disc 144 and may secure the threaded disc 144 at a desired longitudinal position within the bore 150.

As shown, the spring 142 may be positioned and compressed between the cam 140 and the threaded disc 144 within the bore 150. Accordingly, when the threaded disc 144 is secured in position within the bore 150, the spring 142 may apply a force on the cam 140, urging the cam 140 toward the base end 154 of the bore 150.

The amount the spring 142 is compressed may be adjusted by varying the longitudinal position of the threaded disc 144 within the bore 150. That is, for example, the further the threaded disc 144 is rotated into the bore 150, the more compressed the spring 142 may become. As will be described in more detail below, the compression level of the spring 142 may be varied to vary the torque limit of the torque limiting mechanism 108.

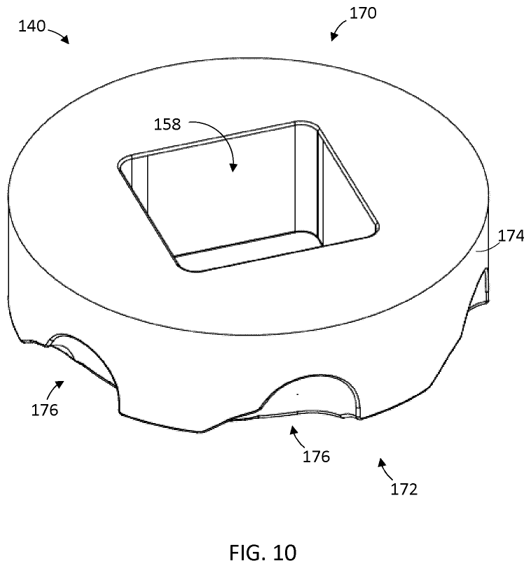

Still referring to FIG. 5, the opening 138 at second housing end 134 may extend to the bore 150 allowing for the drive extension 104 to engage the cam 140 housed within the bore 150. That is, a terminal end 157 of the drive extension 104 may extend through the opening 138 and engage a receiving hole 158 (see FIG. 10) of the cam 140 so that a rotational force applied by an operator to the ratchet 102 may be transferred to the cam 140 via the drive extension 104.

As shown in FIGS. 5 and 9, the plurality of detent elements 145 are also positioned within the housing 130 of the torque limiting mechanism 108. As shown in FIG. 5, each ball bearing 146 may be positioned within a respective bearing cavity 160 at the base end 154 of the bore 150. Each bearing cavity 160 is sized and shaped so that a portion of an outer surface 162 of the ball bearing 146 posited therein engages the cam 140. Accordingly, force applied by the spring 142 onto the cam 140 is transferred from the cam 140 to the detent elements 145. The detent elements 145 may be equally spaced about the circumference of the bore 150. As shown, each ball bearing 146 may be held within its respective bearing cavity 160 by a set screw 166.

A distance 168 that each detent element 145 extends beyond the base end 154 of the bore 150 may be adjusted. In the example illustrated, the distance 168 that each ball bearing 146 extends beyond the base end 154 may be adjusted by varying the position of the set screw 166. Accordingly, the set screws 166 may adjust the distance 168 that each ball bearing 146 extends beyond the base end 154 of the bore 150 which may increase and/or decrease the compression of the spring 142. Accordingly, as described in more detail below, the distance 168 that each detent element 145 extends beyond the base end 154 (e.g. the position of the set screws 166) may be varied to adjust the torque limit of the torque limiting mechanism 108.

With reference to FIG. 9, in the example illustrated, the torque limiting mechanism 108 includes three detent elements 145 (i.e. ball bearings 146 and three set screws 166). In other examples, the torque limiting mechanism 108 may include more or less than three detent elements 145. Further, in example shown, the spring 142 is a disc spring. In other examples, the spring 142 may not be a disc spring, and may be, for example, a helical spring, a wave spring, a leaf spring, etc. In other examples, the spring 142 may not be a spring, per se, but may be any mechanism capable of biasing the cam 140 toward the detent elements 145 (e.g. a compressible fluid, foam, etc.).

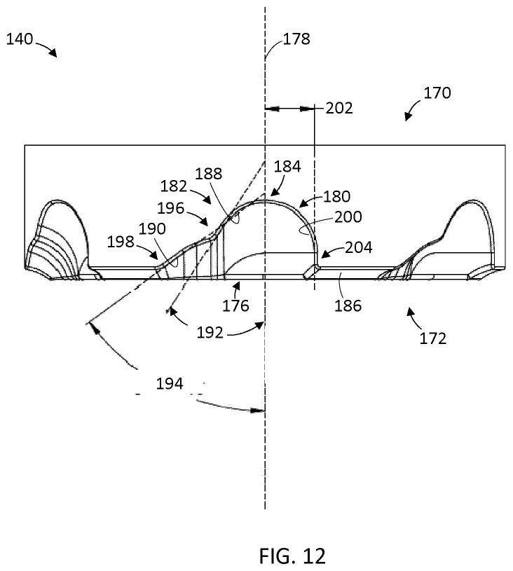

Referring to FIGS. 10 to 12, the cam 140 includes a first cam end 170 opposite a second cam end 172, and a cylindrical sidewall 174 extends therebetween. As shown in FIG. 12, a central axis 178 of the cam 140 extends between the first cam end 170 and the second cam end 172. In the example illustrated, the central axis 178 of the cam 140 is aligned the central axis 136 of the torque limiting mechanism 108 and is aligned with the central axis 116 of the oil filter socket 106.

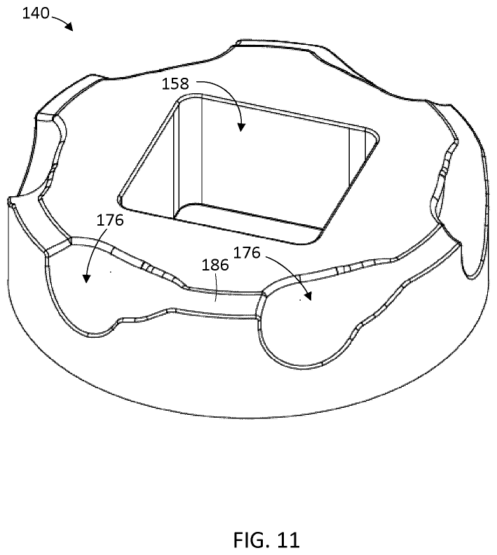

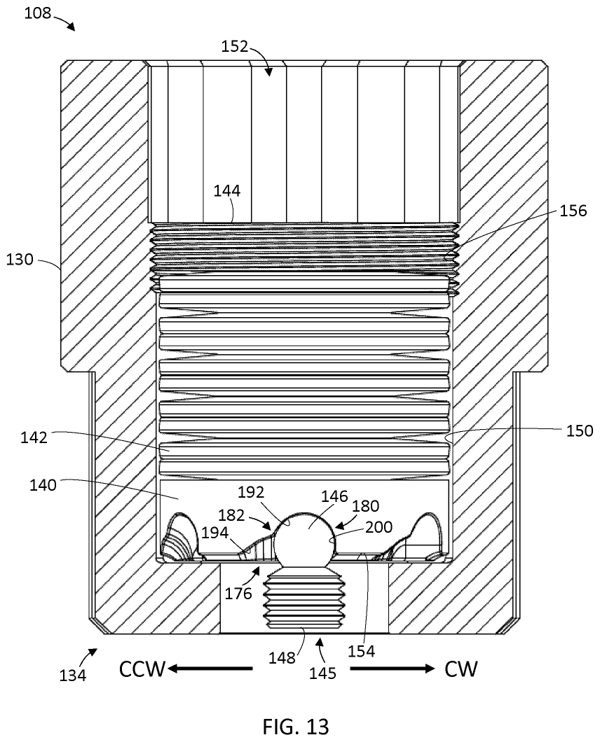

In the example illustrated, the cam 140 includes a plurality of circumferentially extending notches 176 configured to receive a portion of a respective detent element 145 (e.g. ball bearing 146 as shown in FIGS. 13 to 15). In the example shown in FIG. 11, the cam includes six notches 176. Accordingly, as the example illustrated includes three detent elements 145, every other notch 176 may receive a detent element 145 at one time. In other examples, the cam 140 may include more or less than six notches 176, and the number of detent elements 145 may be equal to or less than the number of notches 176.

Referring to FIG. 12, each notch 176 is defined by a first sidewall 180 and a second sidewall 182. As shown, the first sidewall 180 extends from a deepest point 184 of the notch 176 to a second end surface 186 of the second cam end 172 of the cam 140. The second sidewall 182 also extends from the deepest point 184 of the notch 176 to the second end surface 186 of the cam 140, but in an opposite circumferential direction from the first sidewall 180 (i.e. extending away from the first sidewall 180). As shown in FIG. 11, a portion of the second end surface 186 may extend between adjacent notches 176. In the example illustrated, the portion of the second end surface 186 of the cam 140 that extends between adjacent notches 176 is recessed. In some examples, the second end surface 186 may not be recessed between adjacent notches 176.

As shown in FIG. 12, the second sidewall 182 may define a first pocket 188 and a circumferentially spaced apart second pocket 190. The first pocket 188 and the second pocket 190 may be distinguished from each other because a tangential angle 192 of the first pocket 188 is different from a tangential angle 194 of the second pocket 190. The tangential angle 192 of the first pocket 188 may be between 1 and 89 degrees. Likewise, the tangential angle 194 of the second pocket 190 may be between 1 and 89 degrees. In the example illustrated, the tangential angle 194 of the second pocket 190 is greater than the tangential angle 192 of the first pocket 188. In other examples, the tangential angle 194 of the second pocket 190 may be less than the tangential angle 192 of the first pocket 188.

The tangential angle 192, 194 of a pocket 188, 190 can be measured at a distal end 196, 198 of that pocket and can be measured relative to the central axis 178 of the cam. The distal end 196, 198 of the pocket 188, 190 can be the end of the pocket furthest away from the deepest point 184 of the notch 176.

Like the second sidewall 182, the first sidewall 180 also defines a pocket 200 (i.e. third pocket 200) having a tangential angle 202. The tangential angle 202 of the third pocket 200 is measured at a distal end 204 of the third pocket 200 which is the end of the third pocket 200 furthest away from the deepest point 184 of the notch 176. In the example shown, the tangential angle 202 of the third pocket 200 is infinite as the tangential angle 202 is parallel to the central axis 178. In the example shown, the first pocket 188, the second pocket 190, and the third pocket 200 each have a constant radius of curvature. In other examples, the radius of curvature of the first pocket 188, the second pocket 190, and the third pocket 200 may not be constant.

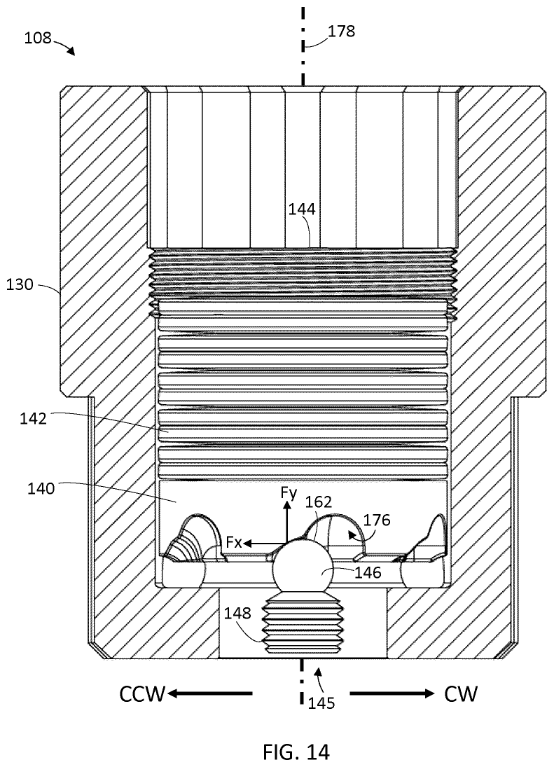

Referring to FIGS. 13 and 14, when the detent element 145 is received by the notch 176 and the cam 140 is rotated in the counterclockwise direction (CCW), the first sidewall 180 of the notch 176 (i.e. the third pocket 200) will engage the ball bearing 146 received by that notch 176. When the ball bearing 146 is received by the notch 176 and the cam 140 is rotated in the clockwise direction (CW), the second sidewall 182 of the notch 176 (i.e. one of the first pocket 188 and the second pocket 190) will engage the ball bearing 146.

Referring to FIG. 12, when the sidewalls 180, 182 have tangential angles 192, 194, 202 between 0 and 90 degrees, the force between the sidewalls 180, 182 of the notch 176 and the ball bearing 146 will have a first force component, Fx, perpendicular to the central axis 178 and a second force component, Fy, parallel to the central axis 178. When the second force component, Fy, is equal to or greater than the compression force of the spring 142, the spring 142 will compress as the cam 140 rotates and follows the outer surface 162 of the ball bearing 146. That is, the cam 140 will follow the outer surface 162 of the detent element 145 and shift, for example, from the first pocket 188 (FIG. 13) to the second pocket 190 (FIG. 14). When the second force component, Fy, is less than the compression force of the spring 142, rotation of the cam 140 will not cause compression of the spring 142, and therefore, rotation of the cam 140 will cause rotation of the housing 130 (and the cup 120 when secured to the housing 130) as the ball bearings 146 are fixed within the housing 130.

Therefore, the tangential angle 192 of the first pocket 188 can be selected so that the ball bearing 146 moves from the first pocket 188 to the second pocket 190 when a predetermined amount torque (i.e. a torque limit) is applied to the cam 140. That is, for example, if an oil filter 110 is to be tightened to 10 ft. lbs. of torque, the tangential angle 192 of the first pocket 188 and the force required to compress the spring 142 can be set so that the spring 142 compresses when, for example, 10.1 ft. lbs. of torque is applied by the operator onto the wrench 102. Accordingly, in this example, when 10.1 ft. lbs. of torque is applied by the operator onto the wrench 102, the cam 140 will follow the ball bearing 146, shifting the ball bearing 146 from the first pocket 188 to the second pocket 190.

When the detent element 145 shifts from the first pocket 188 to the second pocket 190, because the two pockets 188, 190 have different tangential angles 192, 194, the operator will receive haptic feedback through the wrench 102 which is a signal that at least the desired level of torque (i.e. the torque limit) has been applied to the oil filter 110.

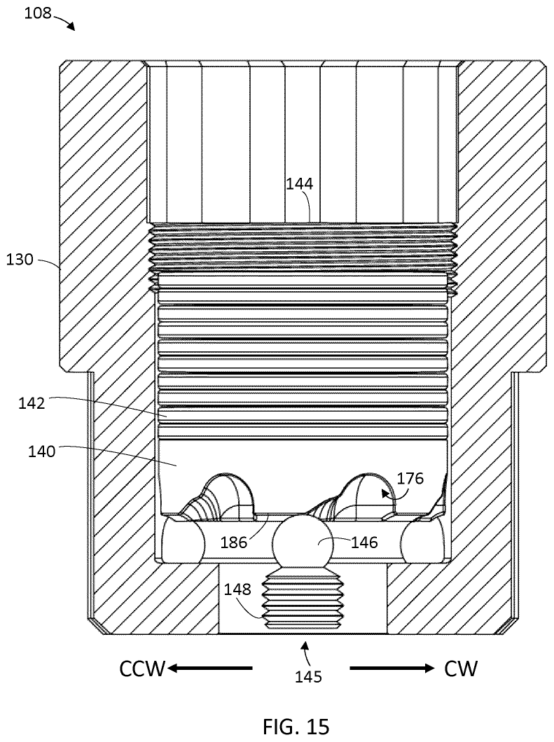

If the user continues to increase the torque applied to the cam 140, the ball bearing 146 may shift from the second pocket 190 (FIG. 14) to the second end surface 186 (FIG. 15). As used in the description and the claims, when ball bearing 146 engages the second end surface 186, this is referred to as a slip position. As shown in FIG. 15, the second end surface 186 may be perpendicular to the central axis 116, and therefore, the ball bearing 146 may readily slide (i.e. slip) along the second end surface 186 toward an adjacent notch 176. When shifting from the second end surface 186 to the adjacent notch 176, the operator will again receive haptic feedback signaling the operator that at least the desired level of torque has been applied to the oil filter 110.

In some examples, the torque applied to the cam 140 required to shift the ball bearings 146 from the first pocket 188 (i.e. from a torque application position) to the second pocket 190 (i.e. a torque signaling position) may be less than the torque required to shift the ball bearings 146 from the second pocket 190 (i.e. the torque signaling position) to the second end surface 186 (i.e. an over torque/slip position). This may be desirable so that the operator receives haptic feedback that the desired torque has been achieved (i.e. when the ball bearings 146 shift from the first pocket 188 to the second pocket 190) without allowing the cam 140 to slip freely with respect to the ball bearings 146 (see FIG. 15). It may be desirable to allow the cam 140 to slip freely with respect to the ball bearings 146 when a torque sufficiently greater than the torque limit has been applied so that the operator does not damage, for example, the oil filter 110 and/or the engine.

In some examples, the tangential angle 194 of the second pocket 190 may be less than the tangential angle 192 of the first pocket 188 which may result in the torque required to shift the ball bearings 146 from the first pocket 188 to the second pocket 190 be less than the torque required to shift the ball bearings 146 from the second pocket 190 to the second end surface 186.

In some examples, the spring 142 may be a variable-rate spring. That is, the force required to compress the spring 142 may increase as the spring 142 is further compressed.

For example, it may take 10 ft. lbs. of force to compress the spring 142 10 mm from its neutral position to a first compressed position and it may take 12 ft. lbs. to compress the spring 142 10 mm from the first compressed position to a second compressed position.

Therefore, in an example where the tangential angle 192 of the first pocket 188 is equal to the tangential angle 194 of the second pocket 190, a first torque applied to the cam 140 may generate a force component Fy greater than the compression force of the spring 142 when the ball bearing 146 is in the first pocket 188 but may not generate a force component Fy greater than the compression force of the spring 142 when the ball bearing 146 is in the second pocket 190 because the force required to compress the spring 142 is greater when the ball bearing 146 is in the second pocket 190 compared to when the ball bearing 146 is the in first pocket 188.

Therefore, the ability to rotate the cam 140 relative to the detent elements 145 (i.e. shift the ball bearings 146 from the first pocket 188 to the second pocket 190 and/or from the second pocket 190 to the second end surface 186) is a function of the spring rate of the spring 142 and the tangential angle 192, 194 of the pocket 188, 190.

In some examples, as shown in FIG. 12, due to the spring rate of the spring 142, the tangential angle 194 of the second pocket 190 may be greater than the tangential angle 192 of the first pocket 188 and the torque required to shift the ball bearings 146 from the first pocket 188 to the second pocket 190 is less than the torque required to shift the ball bearings 146 from the second pocket 190 to the second end surface 186.

When a spring 142 having a variable rate is used, the torque limit (i.e. the applied torque to the cam 140 required to shift the ball bearings 146 from the first pocket 188 to the second pocket 190) of the torque limiting mechanism 108 may be adjusted by changing the initial compression of the spring 142. It will be appreciated that changing the initial compression of the spring 142 may also adjust the applied torque required to shift the ball bearings 146 from the second pocket 190 to the second end surface 186. As described above, the initial compression of the spring 142 may be adjusted using the threaded disc 144 and/or the detent elements 145 (e.g., the set screws 148).

The following is intended to be illustrative but non-limiting. Using a spring 142 with a spring rate of 5500 N/mm, preloaded to approximately 820 N when the ball bearings 146 engage the first pocket 188, if the first pocket 188 has a tangential angle 192 of approximately 60 degrees, the ball bearings 146 may shift from engaging the first pocket 188 to engaging the second pocket 190 when a torque of approximately 25 Nm is applied to the cam 140. In this example, the ball bearings 146 may shift from engaging the second pocket 190 having a tangential angle 194 of approximately 40 degrees when a torque of approximately 35 Nm is applied to the cam 140. It is noted that in this example, the tangential angle 194 of the second pocket 190 may be less than the tangential angle 192 of the first pocket 188 but the applied torque required to shift the ball bearings 146 from the first pocket 188 to the second pocket 190 may be less than the torque required to shift the ball bearings from the second pocket 190 to the second end surface 186 because the preload of the spring 142 is greater (in this example approximately 2300 N) when the ball bearings are in the second pocket 190 due to the compression of the spring caused by shifting the ball bearings from the first pocket 188 to the second pocket 190.

Referring to FIG. 13, it may be desirable to provide a pocket 200 of the first sidewall 180 with a very low and/or infinite tangential angle 202 so that the likeliness of the ball bearing 146 shifting when rotating the cam 140 in the counterclockwise direction is minimized. It may not be desirable to allow the ball bearing 146 to shift relative to the cam 140 when rotating the cam 140 in the counterclockwise direction as the cam 140 is rotated in the counterclockwise direction when loosening, for example, an oil filter. Accordingly, a higher level of torque may be applied during the loosing process than in the tightening process. In some examples, the pocket 200 of the first sidewall 180 may be low to allow for slip when high amounts of torque are applied. It may be desirable to allow the cam to slip when rotating in the counterclockwise direction (i.e. allow the ball bearings 146 to shift from the third pocket 200 to the second end surface 186) to ensure excessive torque is not applied to, for example, an oil filter and/or to protect the torque limiting mechanism 108 from mechanical failures due to excessive applied torque.

Therefore, in operation, an operator may grasp the ratchet 102 and releasably attach the drive extension 104 thereto. The terminal end 157 of the drive extension 104 may be inserted through the opening 138 in the second housing end 134 of the housing 130 and may be received by the receiving hole 158 in the cam 140.

If tightening, for example, an oil filter 110, the operator may then selectively adjust the set screws 148 and/or the threaded disc 144 to set a desired torque limit associated with the torque necessary to attach the oil filter 110 to an engine block without over tightening the components together.

As the ratchet 102 is rotated about central axis 116 in the clockwise direction, a reciprocal force is applied to the cup 120 from the threading of the oil filter 110 to the engine block. When the reciprocal force applied to the cup 120 overcomes the torque limit, the ball bearings 146 may shift from the first pocket 188 to the second pocket 190, providing haptic feedback to the operator that the desired torque (i.e. the torque limit) has been reached. If the operator continues to apply an increased torque, the ball bearings 146 may shift from the second pocket 190 to the second end surface 186, and optionally from the second end surface 186 to an adjacent notch 176. This sequence may repeat so long as the operator continues to apply a torque sufficiently greater than the set torque limit.

While the above description provides examples of one or more apparatuses or methods, it will be appreciated that other apparatuses or methods may be within the scope of the accompanying claims.

1. A torque limiting mechanism, comprising:
a housing extending between a first housing end and a second housing end, the housing comprising a bore extending along a central axis within the housing and terminating at a bore base end;
a cam positioned within the bore and extending axially between a cam first end and a cam second end, the cam biased toward the bore base end, and the cam second end comprising a plurality of circumferentially extending notches, each of the notches having a first pocket and a radially spaced apart second pocket, the first pocket has a first tangential angle, the second pocket has a second tangential angle that is not equal to the first tangential angle; and
a plurality of detent elements extending into the bore from the bore base end, each detent element receivable by a respective notch,
wherein the cam is rotatable within the bore about the central axis between a torque application position and a signaling position,
wherein, in the torque application position, the detent elements engage respective first pockets of the plurality of notches, and
wherein, in the signaling position, the detent elements engage respective second pockets of the plurality of notches.

2. The torque limiting mechanism of claim 1, wherein each notch has a first sidewall extending from a deepest point of the notch to the cam second end, and a second sidewall extending away from the first sidewall from the deepest point of the notch to the cam second end, the second sidewall defines the first pocket and the second pocket.

3. The torque limiting mechanism of claim 2, wherein the first sidewall defines a third pocket, the third pocket has a third tangential angle, and the third tangential angle is less than the first tangential angle and the second tangential angle.

4. The torque limiting mechanism of claim 3, wherein the third tangential angle is less than 5 degrees.

5. The torque limiting mechanism of claim 2, wherein the cam second end has a cam second end surface, and a portion of the cam second end surface extends between adjacent notches.

6. The torque limiting mechanism of claim 5, wherein the cam is rotatable from the signaling position, away from the torque application position, to a slip position, and in the slip position, the detent elements engage respective portions of the second end surface extending between adjacent notches.

7. The torque limiting mechanism of claim 6, wherein the portion of the second end surface that extends between adjacent notches is recessed toward the deepest point of the notch.

8. The torque limiting mechanism of claim 1, wherein the second tangential angle is greater than the first tangential angle.

9. The torque limiting mechanism of claim 1, wherein a distance that each detent element extends into the bore from the bore base end is adjustable.

10. The torque limiting mechanism of claim 1, wherein each detent element comprises a ball bearing that engages the notches.

11. The torque limiting mechanism of claim 1, further comprising a spring interior the bore for biasing the cam toward the plurality of detent elements.

12. The torque limiting mechanism of claim 11, wherein the spring is a variable-rate spring.

13. The torque limiting mechanism of claim 11, wherein a portion of an inner surface of the bore is threaded and a threaded disc is received by the bore to secure the spring within the bore.

14. The torque limiting mechanism of claim 13, wherein the threaded disc is moveable between a first securing position and a second securing position, and a torque limit when the threaded disc is in the first securing position is less than a torque limit when the threaded disc is in the second securing position.

15. The torque limiting mechanism of claim 1, wherein the bore extends into the housing from the first housing end, and the bore base end is axially spaced from the housing second end.

16. The torque limiting mechanism of claim 1, wherein the housing comprises an opening that extends from the second housing end to the bore, the cam comprises a receiving hole and, in use, a drive extension extends through the opening and engages the receiving hole.

17. (canceled)

18. The torque limiting mechanism of claim 1, wherein the cam comprises six notches, and the plurality of detent elements consists of three detent elements.

19. An oil filter socket, comprising:
the torque limiting mechanism of claim 1; and
a cup comprising a first end and a second end,
wherein the first end of the cup defines a cavity that is sized and shaped to grip one of an oil filter canister and an oil filter bolt head, and
wherein the torque limiting mechanism is coupled to the second end of the cup.

20. A method, comprising:
providing the oil filter socket of claim 19;
setting a torque limit with the torque limiting mechanism;
connecting the oil filter socket to one of an oil filter canister and an oil filter bolt head; and
rotating the oil filter socket until the detent elements shift from engaging the first pockets to engaging the second pockets signaling that the torque limit has been reached.

21. A mechanism, comprising:
a housing;
a cam; and
at least one detent element,
wherein the cam comprises at least one notch, the notch comprising a first pocket and a second pocket,
wherein the at least one detent element engages the first pocket of the at least one notch when a first torque is applied to the cam, and
wherein the at least one detent element engages the second pocket of the at least one notch when a second torque is applied to the cam.

22. (canceled)
